(19) United States
(12) Patent Application Publication
(10) Pub. No.: US 2013/0327459 A1
(43) Pub. Date: Dec. 12, 2013

(54) TIRE WITH CROWN REINFORCING STRUCTURE

(71) Applicants: Timothy B. Rhyne, Greenville, SC (US); William Bennett Clayton, Simpsonville, SC (US); Antonio Delfino, Grolley (CH); Daniel McEachern Hicks, Greenville, SC (US)

(72) Inventors: Timothy B. Rhyne, Greenville, SC (US); William Bennett Clayton, Simpsonville, SC (US); Antonio Delfino, Grolley (CH); Daniel McEachern Hicks, Greenville, SC (US)

(73) Assignee: COMPAGNIE CENERALE DES ETABLISSEMENTS MICHELIN, Clermont-ferrand (FR)

(21) Appl. No.: 14/000,767

(22) PCT Filed: Feb. 21, 2011
(86) PCT No.: PCT/US11/25584

§ 371 Date: Aug. 21, 2013

(51) Int. Cl. B60C 9/18

(52) U.S. Cl. CPC B60C 9/18
USPC 152/527

(57) ABSTRACT

A tire having a reinforcement structure with improved resistance to a hinge effect is provided. More particularly, a tire is provided with a reinforcement structure that is positioned in the crown portion of the tire. The reinforcement structure has a circumferential extension modulus of about 5 GPa or greater and an axial plane shear modulus of about 10 MPa or greater. Exemplary embodiments of a tire with the reinforcement structure are provided.

### FIELD OF THE INVENTION

The present invention relates to a tire having a reinforcing structure contained in the crown.

### BACKGROUND OF THE INVENTION

In heavy, commercial truck applications, such as tractor-trailer combinations and the like, the weight of the tires can add considerable mass and rolling resistance. Such is due in part to e.g., the large size of the tires as well as the construction that is required for carrying heavy loads. For a tractor-trailer combination having 10, 16, or 18 wheels, the fuel consumption associated with the mass and rolling resistance of the tires can be very significant.

One of many challenges in the design for certain heavy, commercial truck tire applications involves a phenomena referred to as the “hinge effect.” During operation, the shoulders of the tires may “hinge” out of contact with the ground and thereby allow greater counter deflection at the center of the tire, which results in less stiffness. Lower stiffness in turn results in higher rolling resistance and, therefore, decreased fuel efficiency. In addition, the weight bearing capacity of the tire is reduced. Typically, the extent of the binge effect can increase as the tire width is increased.

The hinge effect can also provide for an unfavorable shape for the contact patch. Typically, at maximum load the hinge effect can lead to a shorter contact occurring in the center of the tread and a longer contact occurring on the shoulders. Such activity has a deleterious effect on tread wear and rolling resistance.

The hinge effect can also increase sensitivity of the tire to load variations. For example, in the contact patch, the shoulder ribs may experience a shorter contact with the ground than the center ribs for smaller loads. However, at larger loads the shoulder ribs may be in much longer contact with the ground than the center ribs. This variation in the shape of the contact patch can also provide for excessive tread wear and increased rolling resistance.

One approach for addressing the hinge effect is to provide several support belts in the crown portion of the tire. For example, additional metal belts with metal cables at various angles can be provided to stiffen the tire and, therefore, reduce the hinge effect. Unfortunately, the addition of such belts also adds weight, which negatively affects the tire's fuel economy. Depending on the construction of the additional belts, additional heat generation can occur that also increases rolling resistance.

Accordingly, a tire that can have improved rolling resistance, tread wear, and load capacity would be useful. More particularly, a tire that can minimize or avoid the hinge effect without significantly increasing the mass or rolling resistance of the tire would be very beneficial. Such a tire that can also realize increased load capacities and improvement in durability would also be particularly useful.

### SUMMARY OF THE INVENTION

Aspects and advantages of the invention will be set forth in part in the following description, or may be obvious from the description, or may be learned through practice of the invention.

In one exemplary embodiment, the present invention provides a tire defining a radial direction and having an axis of rotation. The tire includes a crown portion having a tread. A reinforcement structure extends in the crown portion and is disposed radially inward of the tread. The reinforcement structure has a circumferential extension modulus of about 5 GPa or greater and an axial plane shear modulus of about 10 MPa or greater.

The tire includes a pair of axially spaced-apart, annular bead portions. A pair of sidewall portions extend radially between a respective axial edge of the crown portion and a respective bead portion. A carcass ply extends between the bead portions, through the sidewall portions, and through the crown portion. The carcass ply is disposed radially-inward of the reinforcement band in the crown portion.

The reinforcement structure can comprise a layer of at least one filament wound about the axis of rotation of the tire. The filament of the reinforcement structure can include a fiber selected from the group comprising polyvinyl alcohol fibers, aromatic polyamide (or “aramid”) fibers, polyamide-imide fibers, polyimide fibers, polyester fibers, aromatic polyester fibers, polyethylene fibers, polypropylene fibers, cellulose fibers, rayon fibers, viscose fibers, polyphenylene benzobisoxazole (or “PBO”) fibers, polyethylene naphthenate (“PEN”) fibers, glass fibers, carbon fibers, silica fibers, ceramic fibers, and mixtures of such fibers. Such fibers can be embedded in a resin having a tensile modulus of about 10 MPa or greater. The reinforcement structure can have a thickness of about 1 mm or greater along the radial direction.

The reinforcement structure can further include a support band positioned in the crown. The support band can include at least one coil of a metal cable wound about the axis of rotation of the tire. The support band can be positioned radially outward of the layer of at least one filament.

The reinforcement structure can be constructed from a plurality of layers that each has at least one filament wound about the axial direction. A plurality of separating layers can be provided, where each is constructed from a rubber material and is positioned between the layers having at least one filament. The plurality of layers having at least one filament and/or the plurality of separating layers can each have a thickness of the less than about 1 mm. The filaments of the plurality of layers can be oriented at various angles. For example, the reinforcement structure can be constructed having at least one filament with portions that are oriented at angle of about 45 degrees with respect to the circumferential plane of the tire.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 provides a cross-sectional view of an exemplary embodiment of a tire according to the present invention.

FIG. 2 provides a perspective, break away view of the exemplary embodiment of FIG. 1.

FIGS. 3 through 5 illustrate additional, cross-sectional views of exemplary embodiments of the present invention.

FIG. 6 is a graph providing certain data regarding an exemplary embodiment of the present invention as more fully described below.

The use of identical or similar reference numerals in different figures denotes identical or similar features.

### DETAILED DESCRIPTION OF THE INVENTION

The present invention provides a tire having a reinforcement structure that can improve resistance to the hinge effect. More particularly, the tire is provided with a reinforcement structure that is positioned in the crown portion of the tire. The reinforcement structure has a circumferential extension modulus of about 5 GPa or greater and an axial plane shear modulus of about 10 MPa or greater. For purposes of describing the invention, reference now will be made in detail to embodiments and/or methods of the invention, one or more examples of which are illustrated in or with the drawings. Each example is provided by way of explanation of the invention, not limitation of the invention. In fact, it will be apparent to those skilled in the art that various modifications and variations can be made in the present invention without departing from the scope or spirit of the invention. For instance, features or steps illustrated or described as part of one embodiment, can be used with another embodiment or steps to yield a still further embodiments or methods. Thus, it is intended that the present invention covers such modifications and variations as come within the scope of the appended claims and their equivalents.

The following terms are defined as follows for this disclosure:

“Circumferential plane” means a plane perpendicular to the tire's axis of rotation and passing through the tread. This plane is designated with “CP” in the figures.

“Circumferential extension modulus” refers to the stiffness along the circumferential direction of the tire at an angle that is perpendicular to the axis of rotation of the tire.

“Axial plane shear modulus” refers to the shear modulus in the plane that includes both a tangent to the circumferential direction of the tire as well as a line that is parallel to the axis of rotation of the tire.

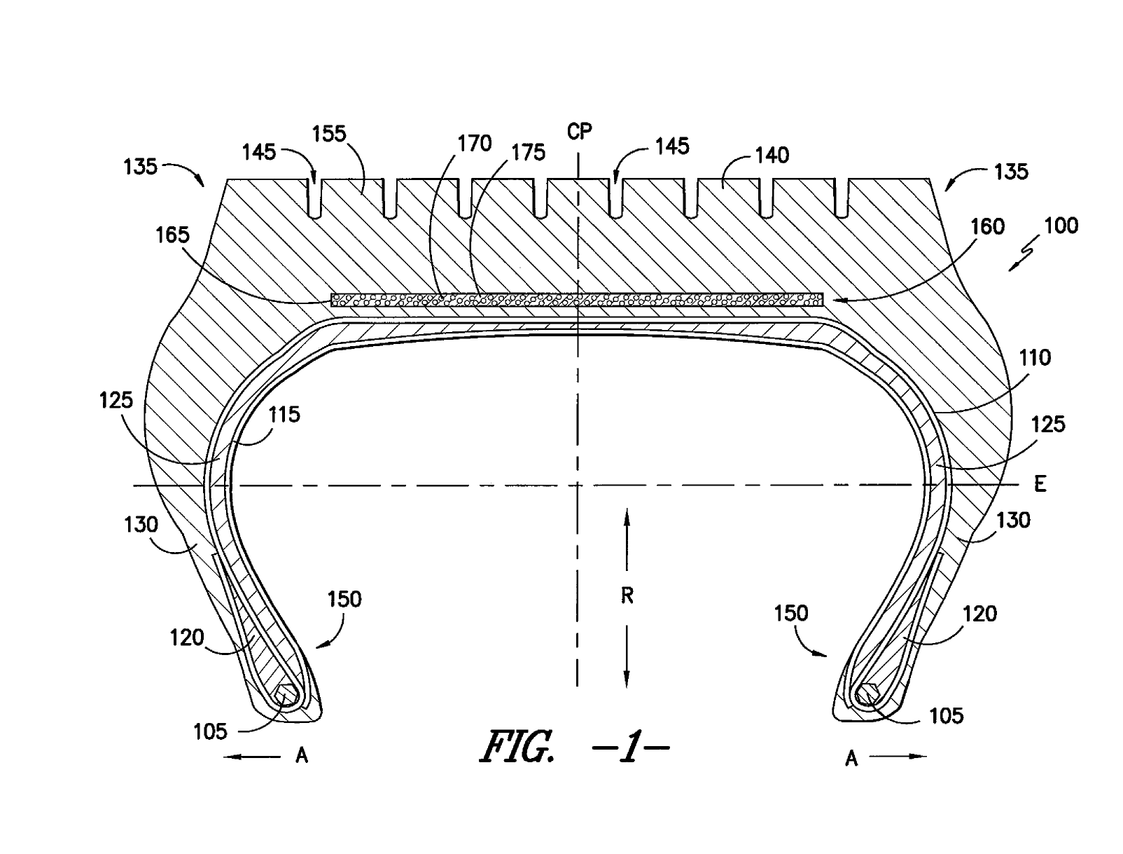

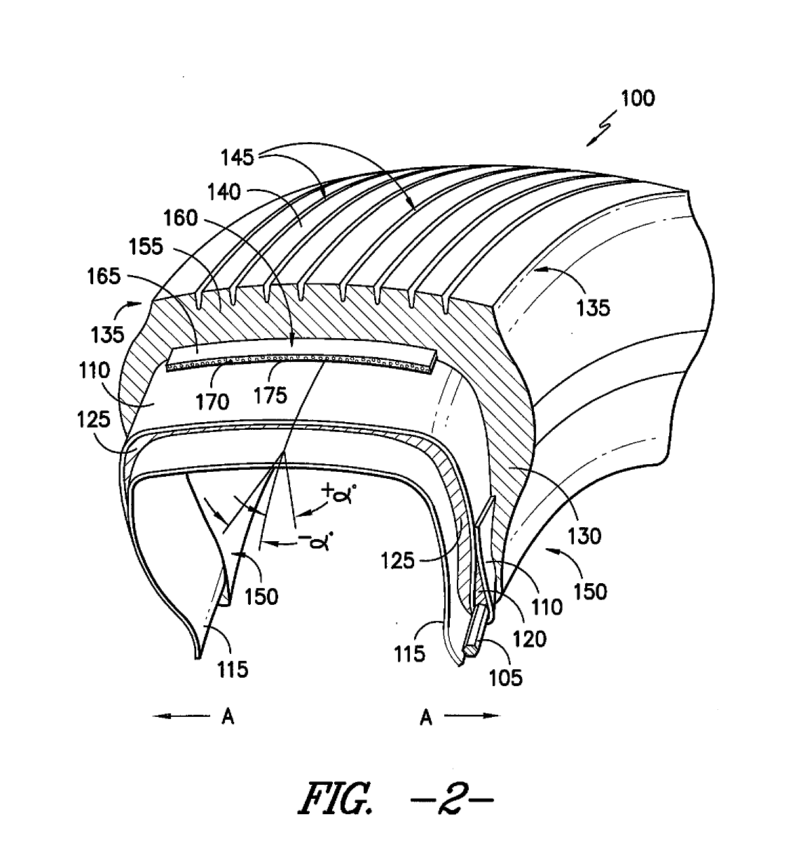

Referring now to FIGS. 1 and 2, an exemplary embodiment of a tire 100 according to the present invention is provided. Arrows A refer to the axial directions, which are parallel to the axis about which tire 100 would rotate during operation and perpendicular to the circumferential plane CP. Arrows R refer to radial directions, which are perpendicular to the axis of rotation and parallel to circumferential plane CP.

Tire 100 includes a tread 140 that extends between sidewall portions 130. Grooves 145 separate ribs 155 in tread 140. Each sidewall portion 130 extends between tread 140 in crown portion 135 and a bead portion 150, which is located radially-inward of sidewall portion 130. Bead portions 150 each comprise a bead core 105 and a bead apex 120.

Sidewall portions 130 help protect a carcass 110 that extends between the bead portions 150. Carcass 110 also wraps around bead cores 105 and bead apex 120 along each side of tire 100. It should be understood, however, that the present invention is not limited to tire constructions where carcass 110 is wrapped about bead cores 105 and/or bead apex 120 and includes, instead, other constructions where e.g., the carcass ends, or is anchored in, the bead portion as well. Carcass 110 may be constructed from a variety of materials including, by way of example, steel and various textile materials such as polyester, nylon, or rayon.

For the exemplary embodiments of FIGS. 1 and 2, tire 100 includes an inner liner 115 that covers the inner surface of tire 100. Inner liner 115 may be constructed from any material suitable for retaining the tire's inflation pressure. For example, inner liner 115 may be constructed from a halo-butyl rubber. An inner layer 125 of rubber is positioned between inner liner 115 and carcass 110. Inner layer 125 provides additional support along radial direction R for tire 100.

Using the teachings disclosed herein, one of skill in the art will understand that the present invention is not limited to tire 100 as shown in e.g., FIGS. 1 and 2 and described above. Instead, tires of other constructions may be used as well. For example, a tread 140 with different features may be used. A tire with different constructions for sidewalls 130 and bead portions 150 may also be used. The tire may include additional, conventional reinforcement belts or protector belts in the crown region between the tread 140 and reinforcing structure 160 (more fully described below) as desired. For example, depending on the intended application, additional belts may be desired for protecting the carcass 110 and inner liner 115.

As shown in FIG. 1, tire 100 includes a reinforcing structure 160 located in crown portion 135 at a position that is radially inward of the tread 140. Reinforcing structure 160 has a circumferential extension modulus of about 5 GPa or greater and an axial plane shear modulus of about 10 MPa or greater. Accordingly, reinforcing structure 160 provides a stiffness to tire 100 that resists the hinge effect previously described.

Various constructions may be used to provide the mechanical properties required for reinforcing structure 160. For the exemplary embodiment illustrated in FIGS. 1 and 2, reinforcing structure 160 is constructed from a layer 165 that includes a least one filament 170 wound in a coil-like mariner about the axis of rotation of tire 100 and embedded in a resin 175. For this exemplary embodiment, the angle α (FIG. 2) for the majority of such filaments 170 relative to the circumferential plan CP is about zero degrees. However, other constructions may be used as well. For example, an angle α of plus or minus 45 degrees for filaments 170 may also be used such that the filaments are wound in a crossing manner along the circumferential direction of layer 165. The thickness of layer 165 (i.e. along the radial direction) may be e.g., at least about 1 to 5 mm, although other thicknesses may be used. Preferably, the width of layer 165 (i.e. along the axial direction) is substantially the same width as the crown portion 135.

Any suitable materials meeting the mechanical properties described above may be used for the manufacture of filament 170 and resin 175. By way of example, fibers and matrix material can be obtained commercially in a variety of forms. Fibers are available individually or as roving which is a continuous, bundled but not twisted group of fibers. Fibers are often saturated with resinous material such as polyester resin which is subsequently used as a matrix material. This process is referred to a preimpregnation. These combinations can take the form of tapes, cloth, or mats. These materials are then layed up in the desired dimensions of the reinforcement structure and then cured whereby the resin is polymerized using a number of means including heat, or UV radiation. This curing creates a permanent bond between the fibers and the resin. Ref. Jones, “Mechanics of Composite Materials”, 1975. By way of example, a method and device for manufacture of a composite ring as may be used for reinforcing structure 160 is described in WO2008/080535, which is incorporated herein by reference. As a further example, pre-impregnated composite fiber technology may also be used to manufacture reinforcing structure 160 by wrapping such fiber around a desired shape and curing same in an autoclave.

The fibers may be provided as a spun yarn (or roving) generally comprising a large number (of the order of several hundreds) of individual fibers of a diameter of several microns, these fibers all being side by side and, therefore, substantially parallel to each other, except for a few overlaps. Although it is in fact impossible to guarantee that the fibers will be arranged absolutely perfectly in parallel, the expression “substantially parallel to each other” is intended to indicate that it is not a cabled yarn or a braid and that the fibers are arranged parallel, except for the geometric accuracy of the arrangement.

Another known possibility, which is suitable in particular for the discontinuous manufacture of lengths of the filament, consists of arranging the fibers as desired in a mold, creating a vacuum and finally impregnating the fibers with the resin. The vacuum permits very effective impregnation of the fibers. U.S. Pat. No. 3,730,678 illustrates such impregnation technology.

By way of example, the filament of the reinforcement structure can be constructed from a fiber selected from the group comprising polyvinyl alcohol fibers, aromatic polyamide (or “aramid”) fibers, polyamide-imide fibers, polyimide fibers, polyester fibers, aromatic polyester fibers, polyethylene fibers, polypropylene fibers, cellulose fibers, rayon fibers, viscose fibers, polyphenylene benzobisoxazole (or “PBO”) fibers, polyethylene naphthenate (“PEN”) fibers, glass fibers, carbon fibers, silica fibers, ceramic fibers, and mixtures of such fibers. Other materials may be suitable for the construction of the filament as well.

Resin 175 is preferably selected so as to provide sufficient cohesion between the textile fibers so as to avoid rapid collapse in compression following micro-buckling of the fibers in resin 175. For example, vinyl-ester or epoxy resins can be used. Other resins providing the required mechanical properties for reinforcing structure 160 may also be used.

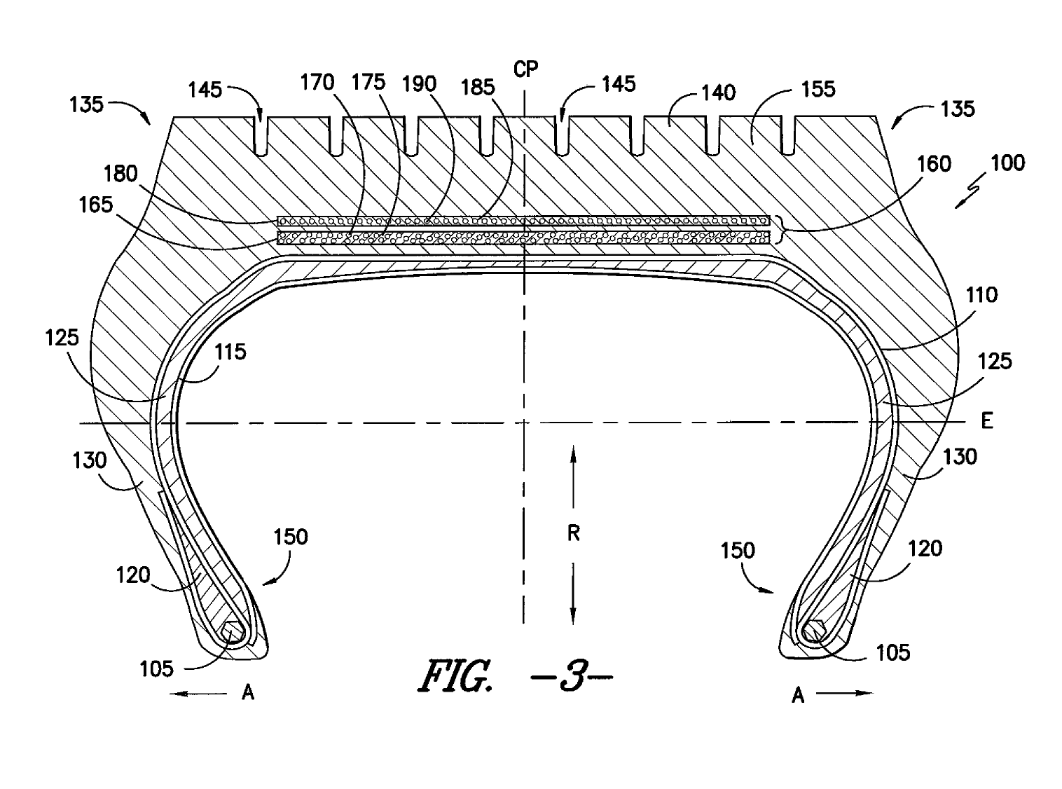

FIG. 3 provides another exemplary embodiment of tire 100 of the present invention having a reinforcement structure 160. As with the embodiment of FIGS. 1 and 2, reinforcing structure 160 has a circumferential extension modulus of about 5 GPA or greater and an axial plane shear modulus of about 10 MPa or greater. Preferably, the width of reinforcing structure 160 is substantially the same width as the crown portion 135. Similarly, a thickness of at least about 1 mm to about 5 mm for structure 160 may be used, although other thicknesses may be used as well.

Reinforcing structure 160 includes a layer 165 that includes a least one filament 170 wound in a coil-like manner about the axis of rotation of the tire along with a resin 175 as previously described. In a manner different than the embodiment of FIGS. 1 and 2, reinforcing structure 160 also includes a support band 180. Although shown at a position radially outside of layer 165, it should be understood that support band 180 can also be located radially inward of layer 165.

Support band 180 is constructed from metal cables 190 and extensible, known as elastic, reinforcement materials 185. For example, metal cables 190 can be provided with low extensibility, that make an angle comprised between 45 degrees and 90 degrees with the circumferential plane CP. The metal cords or threads 190 are typically parallel to one another within a given ply or layer. In addition, support band 180 can include multiple such layers or plies of metal cables 190 wherein the angle of the cables 190 between plies is varied from ply to ply. Together, the multiple plies of support band 180 can provide a triangulated reinforcement which, under the various stresses that it experiences, undergoes very little deformation. Constructions that may be used for support band 180 are set forth e.g., in U.S. Pub. Nos. 2010/0170610; 2010/0147438; 2009/0084485; 2010/0294413; and 2010/00282389. For example, such are referred to in U.S. Pub. Nos. 2010/0170610 as a protective layer.

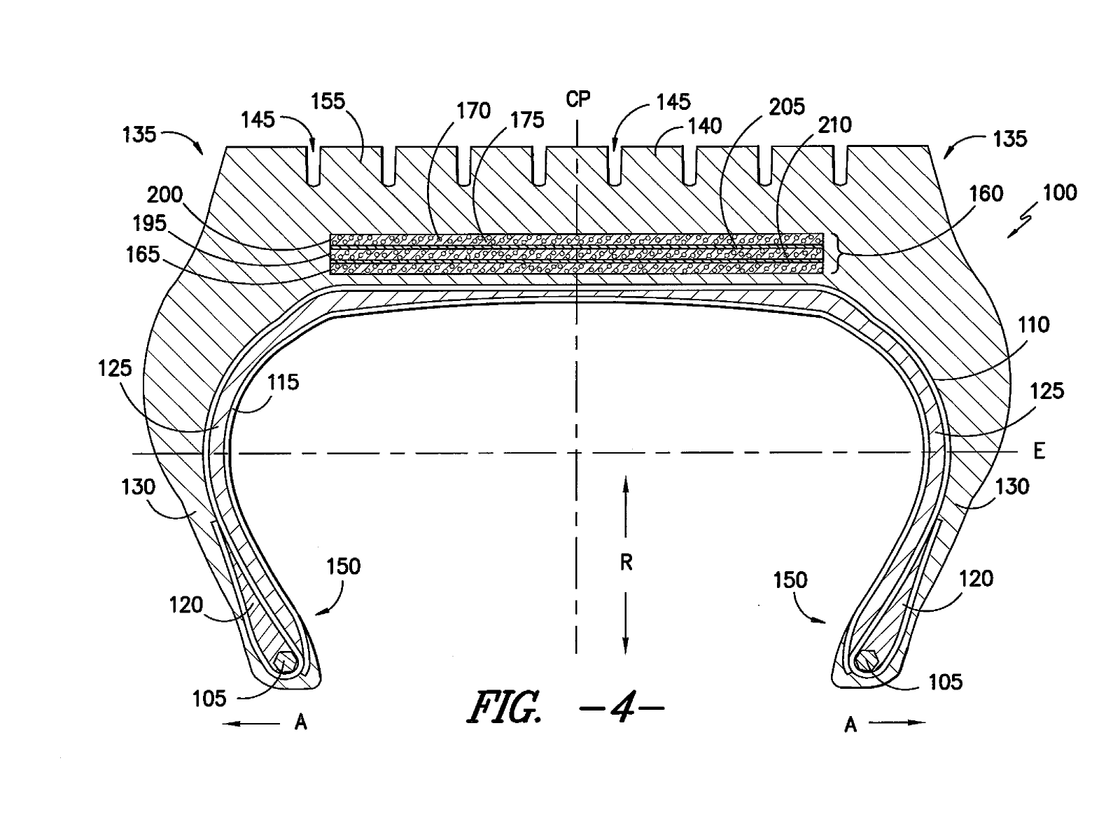

FIG. 4 illustrates another exemplary embodiment of tire 100 of the present invention also having a reinforcement structure 160. As with the embodiment of FIGS. 1 and 2, reinforcing structure 160 has a circumferential extension modulus of about 5 GPa or greater and an axial plane shear modulus of about 10 MPa or greater. However, in a manner different than FIGS. 1 and 2, reinforcement structure 160 in FIG. 4 includes a plurality of layers. More particularly, reinforcement structure 160 includes layers 165, 195, and 200. Each such layer is constructed from at least one filament wound about the axial direction as previously described for layer 165. The filaments of layers 165, 195, and 200 may each be oriented at an angle α of 0 degrees. Alternatively, the filaments of each layer may be set at offsetting angles. For example, the filaments of layer 165 may be arranged substantially at an angle α of +45 degrees, layer 195 at an angle α of −45 degrees, and layer 200 at an angle α of +45 degrees. Other configurations may be used as well.

Separating layers 205 and 210 are positioned between layers 165, 195, and 200. By way of example, separating layers 205 and 210 are constructed from rubber materials and may have a thickness along the radial direction of less than about 1 mm. However, other materials, e,g, polyurethane, may be used for the separating layers as well. Similarly, for this exemplary embodiment, layers 165, 195, and 200 may also have a thickness along the radial direction of less than about 1 mm. Preferably, the width of reinforcing structure 160 is substantially the same width as the crown portion 135. Similarly, an overall thickness of at least about 1 mm to about 5 mm for structure 160 may be used, although other thicknesses may be used as well.

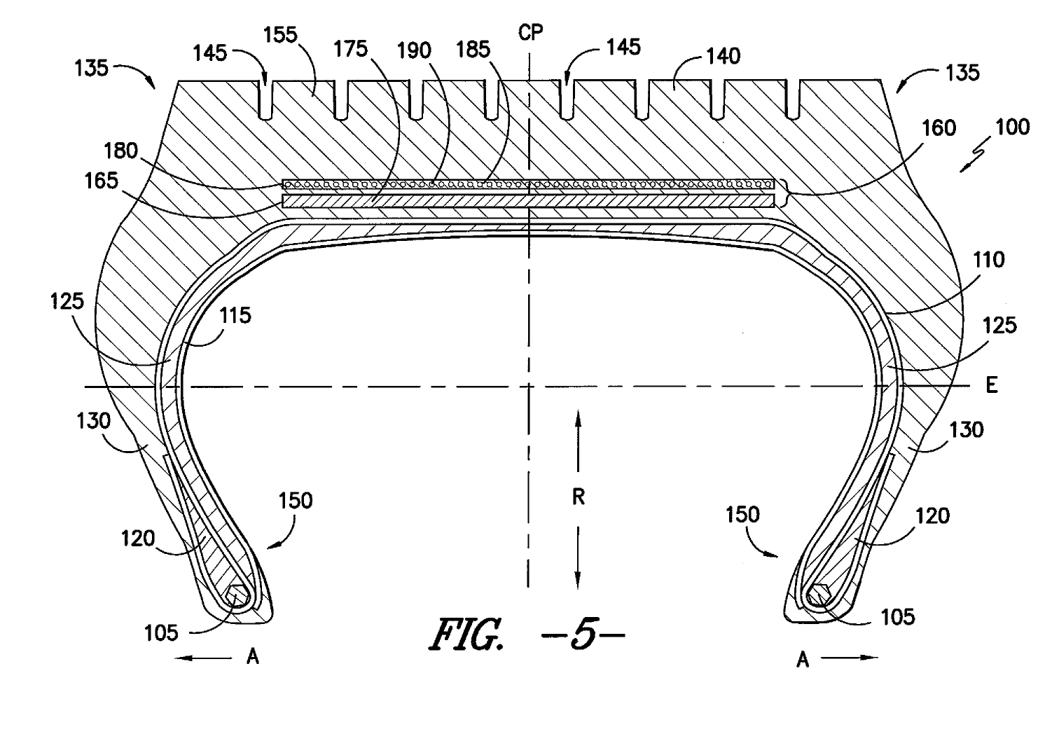

FIG. 5 illustrates still another exemplary embodiment of a tire 100 constructed according to the present invention. For this exemplary embodiment, reinforcing structure 160 includes layer 165 and support band 180. Unlike previous embodiments, layer 165 does not include a filament and, instead, is constructed solely from resin 175. For example, the resin could be constructed from Nylon 66, a polyurethane, thermoplastics, thermosets, or other polymeric materials. Support band 180 is constructed as previously described and includes a layer of metal cable 190 wound about the axis of rotation of the tire. Cable 190 is disposed within a layer 185 of rubber material. As shown in FIG. 5, support band 180 may be spaced apart radially from layer 165. Alternatively, support band 180 may be directly adjacent or in contact with layer 165. Support band 180 may be positioned radially outward of layer 165 as shown in FIG. 5 or, alternatively, may be positioned radially inward of layer 165. Reinforcing structure 160 has a circumferential extension modulus of about 5 GPa or greater and an axial plane shear modulus of about 10 MPa or greater. Preferably, the width of reinforcing structure 160 is substantially the same width as the crown portion 135. Similarly, an overall thickness of at least about 1 mm to about 5 mm for structure 160 may be used, although other thicknesses may be used as well.

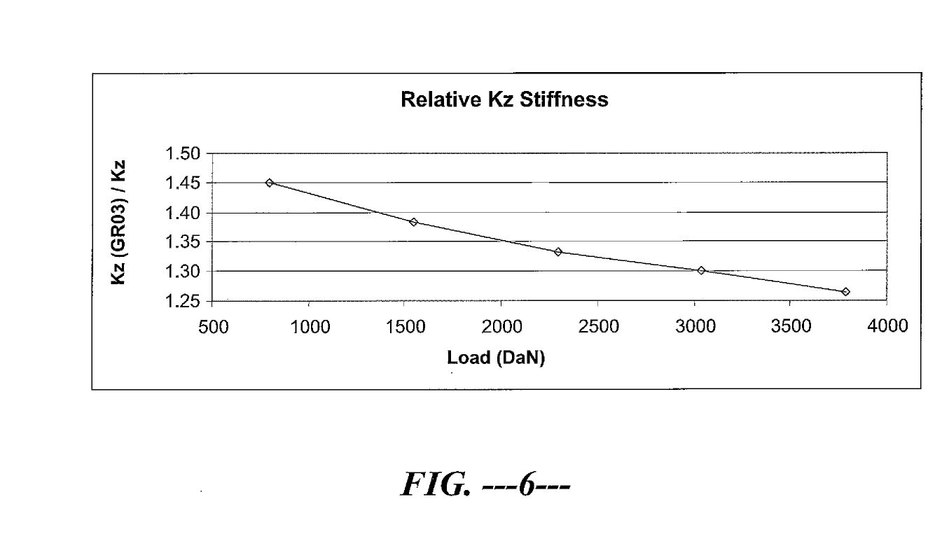

FIG. 6 presents certain data from a simulation designed to explore the effectiveness of an embodiment of the present invention. More particularly, FIG. 6 provides a plot, for various loads, of the ratio of stiffness along the radial direction of a tire constructed with a reinforcing band 160 of the present invention to a reference tire not having reinforcing band 160. As shown, the stiffness of reinforcing band 160 allows tire 100 to operate at a lower deflection, which can improve durability and/or increase load capacity. By way of further example, at the maximum loading condition shown, the simulation projects a stiffness increase of 26 percent while deflection is reduced by 7.7 mm.

The simulation was also used to explore thermal effects as well. It was discovered that a tire with reinforcing band 160 can have a reduction of 23.5° C. in the maximum tire temperature during use as compared to the reference tire. It is believed that this reduction comes from the elimination of parasitic stresses in the crown of the tire that do not add to the function of the tire.

The simulation also revealed that contact stresses along the circumferential direction in a tire with the reinforcing band 160 were more uniform. Thus, along with a lower load sensitivity, the simulation shows that a tire with reinforcing band 160 should realize tread wear improvement relative to the referenced design. Accordingly, reductions in the hinge effect also produced improvements to tread wear.

While the present subject matter has been described in detail with respect to specific exemplary embodiments and methods thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A tire defining a radial direction and having an axis of rotation, the tire comprising:
a crown portion having a tread;
a reinforcement structure extending in said crown portion and disposed radially inward of said tread, said reinforcement structure having a circumferential extension modulus of about 5 GPa or greater and an axial plane shear modulus of about 10 MPa or greater, said reinforcement structure further comprising
a plurality of layers that each have at least one filament wound about the axial direction, and
a plurality of separating layers, each constructed from a rubber material, each said separating layer being positioned between the layers having at least one filament;
a pair of axially spaced-apart, annular bead portions;
a pair of sidewall portions with each said sidewall portion extending radially between a respective axial edge of said crown portion and a respective said bead portion; and,
a carcass ply extending between said bead portions, through said sidewall portions, and through said crown portion, wherein said carcass ply is disposed radially-inward of said reinforcement band in said crown portion.

2. A tire as in claim 1, wherein said reinforcing structure comprises at least one filament wound about the axis of rotation of the tire.

3. A tire as in claim 2, wherein the filament of said reinforcement structure comprises a fiber selected from the group comprising polyvinyl alcohol fibers, aromatic polyamide (or “aramid”) fibers, polyamide-imide fibers, polyimide fibers, polyester fibers, aromatic polyester fibers, polyethylene fibers, polypropylene fibers, cellulose fibers, rayon fibers, viscose fibers, polyphenylene benzobisoxazole (or “PBO”) fibers, polyethylene naphthenate (“PEN”) fibers, glass fibers, carbon fibers, silica fibers, ceramic fibers, and mixtures of such fibers.

4. A tire as in claim 3, wherein said fibers are embedded in a resin having a tensile modulus of about 10 MPa or greater.

5. A tire as in claim 1, wherein said reinforcement structure has a thickness of about 1 mm or greater along the radial direction.

6. A tire as in claim 1, wherein said reinforcement structure further comprises a support band positioned in said crown, said support band comprising at least one coil of a metal cable wound about the axis of rotation of the tire.

7. A tire as in claim 6, wherein the filament of said reinforcement structure comprises a fiber selected from the group comprising polyvinyl alcohol fibers, aromatic polyamide (or “aramid”) fibers, polyamide-imide fibers, polyimide fibers, polyester fibers, aromatic polyester fibers, polyethylene fibers, polypropylene fibers, cellulose fibers, rayon fibers, viscose fibers, polyphenylene benzobisoxazole (or “PBO”) fibers, polyethylene naphthenate (“PEN”) fibers, glass fibers, carbon fibers, silica fibers, ceramic fibers, and mixtures of such fibers.

8. A tire as in claim 7, wherein said fibers are embedded in a resin having a tensile modulus of about 10 MPa or greater.

9. A tire as in claim 8, wherein said support band is positioned radially outward of said layer of at least one filament.

10. (canceled)

11. (canceled)

12. A tire as in claim 1, wherein said plurality of layers that each have at least one filament are also each less than about 1 mm in thickness along the radial direction.

13. A tire as in claim 1, wherein said plurality of separating layers are each less than about 1 mm in thickness.

14. A tire as in claim 1, wherein the filaments of said plurality of layers of said reinforcement structure comprise one or more fibers selected from the group comprising polyvinyl alcohol fibers, aromatic polyamide (or “aramid”) fibers, polyamide-imide fibers, polyimide fibers, polyester fibers, aromatic polyester fibers, polyethylene fibers, polypropylene fibers, cellulose fibers, rayon fibers, viscose fibers, polyphenylene benzobisoxazole (or “PBO”) fibers, polyethylene naphthenate (“PEN”) fibers, glass fibers, carbon fibers, silica fibers, ceramic fibers, and mixtures of such fibers.

15. A tire as in claim 1, wherein said one or more fibers are embedded in a resin having a tensile modulus of about 10 MPa or greater.

16. A tire as in claim 13, where said resin is a vinyl-ester or epoxy resin.

17. A tire as in claim 1, the tire defining a circumferential plane, and wherein at least one of the plurality of layers has at least one filament with portions that are oriented at angle of about 45 degrees with respect to the circumferential plane of the tire.

18. A tire as in claim 1, wherein said reinforcement structure has a thickness of about 1 mm or greater along the radial direction, and a width along the axial direction that is substantially about the same width as the crown portion.
